(19) United States
(12) Patent Application Publication
(10) Pub. No.: US 2019/0101196 A1
(43) Pub. Date: Apr. 4, 2019

(54) BALL SCREW

(71) Applicants: Fu Tai Hua Industry (Shenzhen) Co., Ltd., Shenzhen (CN); HON HAI PRECISION INDUSTRY CO., LTD., New Taipei (TW)

(72) Inventors: LI-CHIN LU, Tu-Cheng (TW); JIAN-HUA XIANG, Shenzhen (CN)

(21) Appl. No.: 15/870,868

(22) Filed: Jan. 13, 2018

(30) Foreign Application Priority Data
Sep. 30, 2017 (CN) 201721295115.3

(51) Int. Cl. F16H 25/22; F16H 25/20; F16H 25/24

(52) U.S. Cl. CPC F16H 25/2214; F16H 25/2472; F16H 25/2025

(57) ABSTRACT

A ball screw includes a screw, a nut, and at least one ball bearing. The screw includes a first helical tooth helically protruding from an outer surface of the screw. A ball groove is defined between adjacent portions of the first helical tooth. The nut includes a second helical tooth helically protruding from an inner surface of the nut. The nut is sleeved on the screw. A rolling groove is defined between adjacent portions of the second helical tooth. The first helical tooth occludes with the rolling groove. The second helical tooth occludes with the ball groove. The first helical tooth and the second helical tooth are alternately helically spaced. The first helical tooth and the second helical tooth cooperatively define a loading groove for receiving the at least one ball bearing.

### CROSS-REFERENCE TO RELATED APPLICATIONS

This application claims priority to Chinese Patent Application No. 201721295115.3 filed on Sep. 30, 2017, the contents of which are incorporated by reference herein.

### FIELD

The subject matter herein generally relates to ball screws.

### BACKGROUND

Generally, ball screws include components that may cause friction when in use.

### BRIEF DESCRIPTION OF THE DRAWINGS

Implementations of the present disclosure will now be described, by way of example only, with reference to the attached figures.

FIG. 1 is an assembled, isometric view of an exemplary embodiment of a ball screw in accordance with an embodiment of the present disclosure.

FIG. 2 is an exploded, isometric view of the ball screw in FIG. 1.

FIG. 3 is a cross-sectional view taken along line in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

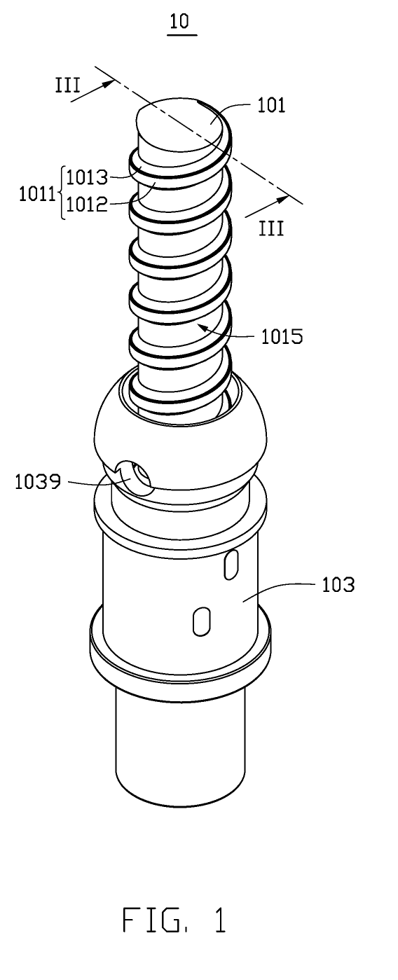

FIG. 1 illustrates an embodiment of a ball screw 10. The ball screw 10 can be used in any kind of industrial equipment and precision equipment.

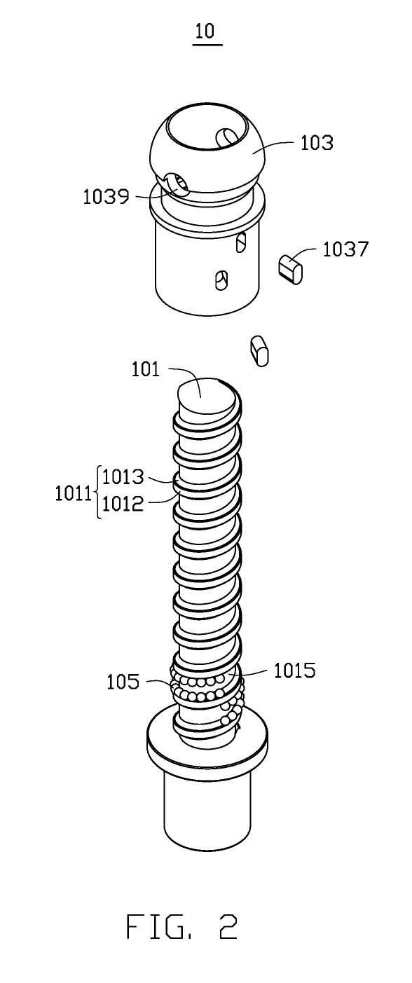

Referring to FIG. 2, the ball screw 10 includes a screw 101, a nut 103, and ball bearings 105. The nut 103 is sleeved on the screw 101. The ball bearings 105 are arranged between the screw 101 and the nut 103. When the nut 103 is moved relative to the screw 101, the ball bearings 105 also move between the nut 103 and the screw 101 to reduce friction between the nut 103 and the screw 101.

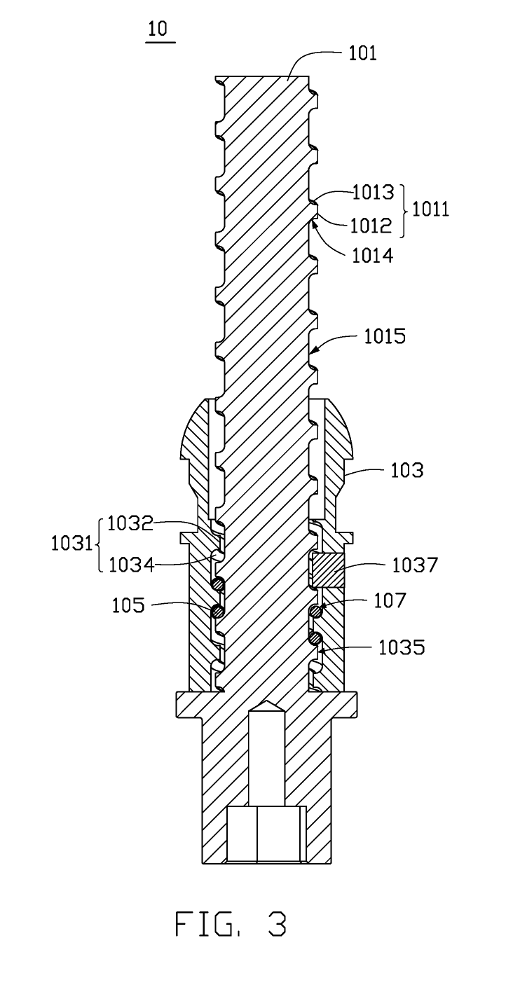

Referring to FIG. 3, the screw 101 is substantially columnar. The screw 101 includes a first helical tooth 1011 protruding from an outer surface of the screw 101. The first helical tooth 1011 is substantially rectangular. The first helical tooth 1011 includes a first apex 1012 and two first sidewalls 1013. The two first sidewalls 1013 are substantially perpendicular to the outer surface of the screw 101. The two first sidewalls 1013 are on opposite sides of the first apex 1012. The first apex 1012 is away from the outer surface of the screw 101 and is substantially parallel to the outer surface. A junction between the first sidewall 1013 and the outer surface of the screw 101 forms a rounded corner 1014 for increased durability.

Adjacent portions of the first tooth 1011 define a ball groove 1015. The ball groove 1015 is bound by a bottom wall (not labeled) and two sidewalls (not labeled). The bottom wall is the outer surface of the screw 101 between adjacent portions of the first helical tooth 1011. The two sidewalls are the adjacent portions of the first tooth 1011. The two sidewalls are opposite to each other to define the ball groove 1015 with the bottom wall.

In at least one embodiment, the ball groove 1015 is used to receive the ball bearings 105. In at least one embodiment, the first apex 1012 extends beyond an axis of the ball bearings 105 to increase a load-bearing capability of the ball screw 10.

In other embodiments, in order to reduce friction and extend a life of the screw 10, two rows of ball bearings 105 can be received in the ball groove 1015, such that each row of ball bearings 105 abuts a corresponding side of the ball groove 1015.

The nut 103 is sleeved on the screw 101. The nut 103 includes a second helical tooth 1031 protruding from an inner surface of the nut 103. The second helical tooth 1031 corresponds to the first helical tooth 1011. In detail, the second helical tooth 1031 has substantially the same structure as the first helical tooth 1011 and includes a second apex 1032 and two second sidewalls 1034. Adjacent portions of the second helical tooth 1031 define a moving groove 1035. The first helical tooth 1011 is occluded in the moving groove 1035, and the second moving tooth 1031 is occluded in the ball groove 1015. Thus, the first helical tooth 1011 and the second helical tooth 1031 are alternately helically spaced. A loading groove 107 is defined between the first helical tooth 1011 and the second helical tooth 1031. The loading groove 107 is used for receiving the ball bearings 105.

In another embodiment, a size of the first helical tooth 1011 is smaller than a size of the rolling groove 1035, and a size of the second helical tooth 1031 is smaller than a size of the ball groove 1015. In this way, when the first helical tooth 1011 is occluded in the rolling groove 1035 and the second helical tooth 1031 is occluded in the ball groove 1015, the first helical tooth 1011 and the second helical tooth 1031 cooperatively define two loading groove 107, such that each loading groove 107 can receive a corresponding row of ball bearings 105.

In at least one embodiment, the first helical tooth 1011 received in the rolling groove 1035 does not contact sides of the rolling groove 1035, and the second helical tooth 1011 received in the ball groove 1015 does not contact sides of the ball groove 1015. Thus, the nut 103 can move along the screw 101 without friction.

To prevent the ball bearings 105 from falling out of the ball screw 10, the ball screw 10 can further include at least one stopper 1037 arranged on the inner surface of the nut 103. The stopper 1037 is embedded in the moving groove 1015, and a shape and size of the stopper 1037 corresponds to a shape and size of the moving groove 1015. The stopper 1037 does not contact the bottom wall or sidewalls of the moving groove 1015. Thus, the stopper 1037 does not cause friction with the moving groove 1015.

In at least one embodiment, there are two stoppers 1037 embedded in adjacent portions of the moving groove 1015. Thus, when the nut 103 is rotated, one of the stoppers 1037 pushes the ball bearings 105 to advance, and the other one of the stoppers 1037 prevents the ball bearings 105 from advancing. Therefore, the ball bearings 105 are limited within the two stoppers 1037 in the loading groove 107, and the ball bearings 105 are prevented from falling out.

The nut 103 defines a through hole 1039. The through hole 1039 passes through opposite ends of the nut 103. The ball bearings 105 are loaded in the loading groove 107 through the through hole 1039.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A ball screw comprising:
a screw comprising a first helical tooth helically protruding from an outer surface of the screw, wherein a ball groove is defined between adjacent portions of the first helical tooth;
a nut comprising a second helical tooth helically protruding from an inner surface of the nut, wherein the nut is sleeved on the screw, a rolling groove is defined between adjacent portions of the second helical tooth; and
at least one ball bearing;
wherein the first helical tooth occludes with the rolling groove;
wherein the second helical tooth occludes with the ball groove;
wherein the first helical tooth and the second helical tooth are alternately helically spaced; and
wherein the first helical tooth and the second helical tooth cooperatively define a loading groove for receiving the at least one ball bearing.

2. The ball screw of claim 1, wherein the first helical tooth comprises a first apex and two opposite sidewalls; the two sidewalls are perpendicular to the outer surface of the screw; and the first apex is parallel to the outer surface of the screw.

3. The ball screw of claim 2, wherein the ball groove is bound by a bottom wall and two opposite sidewalls; the bottom wall is the outer surface of the screw between adjacent portions of the first helical tooth; the sidewalls are the first sidewall of adjacent portions of the first helical tooth.

4. The ball screw of claim 2, wherein a junction of the first sidewall and the outer surface of the screw forms a rounded corner.

5. The ball screw of claim 2, wherein the first apex of the first helical tooth extends beyond an axis of the at least one ball bearing.

6. The ball screw of claim 1, wherein the nut further comprises at least one stopper arranged on the inner surface of the nut; the stopper is embedded in the ball groove.

7. The ball screw of claim 6, wherein the nut comprises two stoppers embedded in adjacent portions of the ball groove.

8. The ball screw of claim 1, wherein the nut defines a through hole; the through hole passes through the nut; the at least one ball bearing is loaded in the loading groove through the through hole.

9. The ball screw of claim 1, wherein a size of the first helical tooth is smaller than a size of the moving groove; and a size of the second helical tooth is smaller than a size of the ball groove.

10. The ball screw of claim 9, wherein the first helical tooth is arranged within the moving groove; the second helical tooth is arranged within the ball groove; each portion of the first helical tooth and an adjacent portion of the second helical tooth cooperatively defines a loading groove for receiving the at least one ball bearing.
